(19) United States
(12) Patent Application Publication
(10) Pub. No.: US 2026/0354313 A1
(43) Pub. Date: Nov. 12, 2026

(54) HEDGE TRIMMER

(71) Applicant: AUTO TRIMMER AS, SKEIN (NO)

(72) Inventor: Kristian Henrik SVINDAL, SKEIN (NO)

(21) Appl. No.: 19/134,903

(22) PCT Filed: Dec. 21, 2023
(86) PCT No.: PCT/NO2023/060132

§ 371 Date: Jun. 2, 2025

(30) Foreign Application Priority Data
Jan. 2, 2023 (NO) 20230001

(51) Int. Cl. A01G 3/053; A01G 3/04

(52) U.S. Cl. CPC A01G 3/053; A01G 3/0417

(57) ABSTRACT

The invention relates to a motorized hedge trimmer consisting of a clipper that can move along a rail arranged along the top of the hedge so that it can cut or prune a hedge. Additional mowers may be arranged along the sides of the hedge.

### FIELD OF THE INVENTION

The invention concerns a hedge trimmer.

### BAKGROUND

Hedge cutting takes place by a person physically cutting the hedge, either with a hedge trimmer or with a motorized hedge trimmer. The disadvantage of this is that it can be strenuous, both because the tool can be heavy or has to be lifted high. For very high hedges, it is common to use a curtain staircase or similar. However, this work carries a risk of accidents, such as falls or damage when handling the equipment.

With the present invention, the applicant has come up with a simple and effective tool for cutting/trimming hedges. The invention is particularly suitable for trimming tall hedges,

This is achieved by a rear trimmer comprising a rail that runs longitudinally and is attached to support legs anchored to the ground, a control unit designed to move along the rail, and where a clipper arranged on the control unit is arranged to cut or prune the top of the hedge.

The rail makes it possible to achieve a smooth trimming that gives the hedge a neater appearance.

In one aspect of the invention, arms are arranged across the rail that can be extended to fit the width of the hedge.

In another aspect of the invention, additional arms extending downwards from the first arms down along the sides of the hedge are provided, as the arms are fitted with clippers to cut the sides of the hedge.

### DESCRIPTION OF THE FIGURES

The invention shall in the following described with reference to the enclosed drawings, where:

FIG. 1 shows the unit as seen from above,

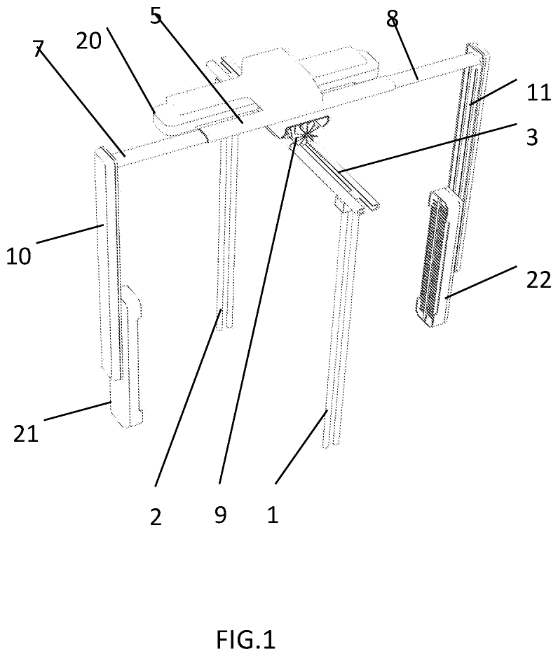

FIG. 2 shows the unit as seen from below, and

FIG. 4 shows the cutting part.

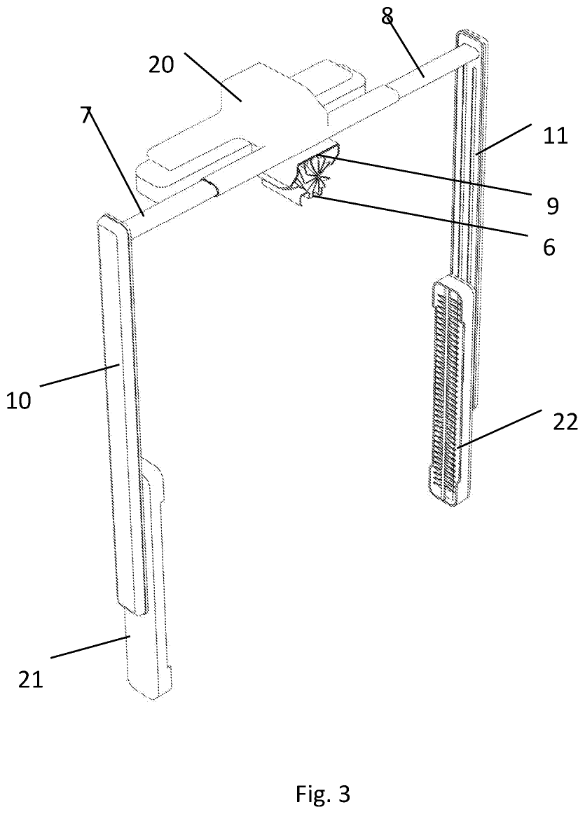

### BRIEF OVERVIEW OF THE DRAWINGS

A rail 3 is arranged in the longitudinal direction of the hedge. It runs along the middle and is preferably positioned so that it is located slightly below the top of the hedge. Preferably, it is placed about 10 cm below the highest point of the hedge or the height it is desirable for the hedge to have. Two support legs 1 and 2 supports each end 3 of the rail (i.e. the ends of the hedge) and are arranged to be anchored in the ground.

If the hedge is long, there may be provided additional support legs.

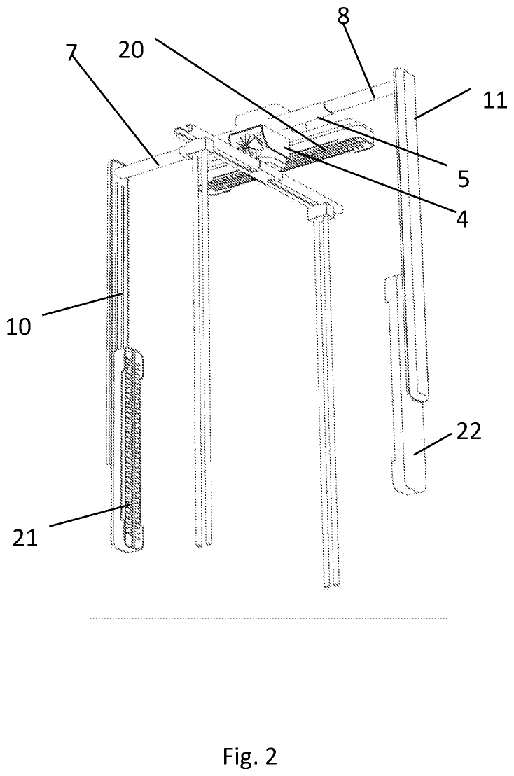

On the rail 3 there is provided a steering and motor unit 4 (FIG. 2). The unit has a lower part 6 (FIG. 3) which is designed to interact with rail 3 so that the unit can move in a controlled manner along the rail 3. In one embodiment, the device includes a motor (not shown) for moving the device. The motor can rotate one or more wheels so that the wheel runs along the rail 3. Alternatively, a rack and pinion system can be used. However, a person skilled in the art will understand that there are several ways to perform this function.

A device 9 (FIG. 2) is provided to remove any debris that may settle in the rail during the work. This can be, for example, a fan, a brush or a milling machine, which will make it possible to remove small branches and such that can grow into the rail.

In the unit 4 there are provided functions for the operation of the hedge trimmer, such as a power supply. This could be a battery. Alternatively, the rail 3 can be live and connected to mains power.

A computer unit can be built into unit 4 for controlling the hedge trimmer.

The unit 4 includes a beam 5 that is oriented perpendicular to the rail 3. A cutting device 20 is attached to the undersides of the beam 5. In an embodiment, the cutter is designed to move relative to beam 5 so that it can be used on hedges of different widths. Alternatively, interchangeable mowers can be used, selected based on the width of the hedge.

Beam 5 is hollow and there are two arms 7 and 8 arranged so that they can move in and out of beam 5. That is, the arms can be stretched out to adapt the width of the device to the width of the hedge. This makes it possible to use the equipment for different widths of hedges.

At each end of arms 7.8 are arranged vertical arms 10, 11 extending down towards the ground. The arms are preferably adjustable in length to be used on hedges of different heights.

On the arms, additional cutting devices 21, 22 are mounted. The cutters are designed to move upwards and downwards along the arms 10, respectively, 11 These are used to trim the sides of the hedge.

In an alternative embodiment, the arms (7, 8) may be arranged to move forward to also take the ends of the hedge.

Several modifications are possible within the scope of the invention. For example, it may include means of remote control of the mowers. The data unit may also enable autonomous operation if desired.

1. Hedge trimmer, comprising a rail that runs longitudinally and is attached to support legs anchored to the ground, a control unit designed to move along the rail, and where a cutter arranged on the control unit is arranged to cut or prune the top of the hedge.

2. The hedge trimmer according to claim 1, characterized by the arms that are attached to the control unit.

3. The hedge trimmer according to claim 2, characterized by the arms which are extendable.

4. The hedge trimmer according to claim 1, characterized by additional arms that are attached to the first arms and extending downwards along the sides of the hedge.

5. The hedge trimmer according to claim 4, characterized by additional cutters that are arranged on the arms.

6. The hedge trimmer according to claim 5, characterized by the cutters that are movable along the arms.

7. The hedge trimmer according to claim 1, characterized by the control unit that includes a battery.

8. The hedge trimmer according to claim 1, characterized by the control unit that includes a computing unit.
